(19) United States
(12) Patent Application Publication
(10) Pub. No.: US 2020/0004763 A1
(43) Pub. Date: Jan. 2, 2020

(54) Geo-Location Based Real-Time Digital Platform and Rating System

(71) Applicant: Spot Hype Inc., Washington, DC (US)

(72) Inventor: Ron REED, Washington, DC (US)

(21) Appl. No.: 16/269,235

(22) Filed: Feb. 6, 2019

Related U.S. Application Data
(60) Provisional application No. 62/626,903, filed on Feb. 6, 2018.

(51) Int. Cl. G06F 16/29; H04L 29/08; H04W 4/029

(52) U.S. Cl. CPC G06F 16/29; H04L 67/06; H04W 4/029; H04L 67/04; H04L 67/22

(57) ABSTRACT

In a media platform including a server and a plurality of hand held wireless devices, a method of providing information by defining a geographic boundary associated with an entity, determining hand held wireless devices within the geographic boundary and allowing the users of the hand held wireless devices to create and post content to the server and associating the posted content with the entity and transmitting the content to others. Other information regarding metrics based upon the postings may also be transmitted to other wireless devices.

### CROSS-REFERENCE TO RELATED APPLICATION

This application claims priority under 35 U.S.C. § 119(e) to U.S. Provisional Application No. 62/626,903, filed Feb. 6, 2018, the entire contents of which are incorporated herein by reference.

### BACKGROUND

People have a hard time finding popular places and events if they are new or unfamiliar with a particular location (city, neighborhood, etc.). Current listing platforms rate places based on biased and outdated information. People need to know what is happening around them in real-time so that they can make the best informed decision as to what places/events/activities are worth taking part.

Local businesses have a difficult time marketing themselves to potential customers on major social media platforms. Small businesses have to run promotions in competition with larger national or regional companies, influencers and other content that pulls at the normal user's attention every second. Venues can spend anywhere between 8-12% of their gross revenue on advertising but have no metric of how effective their ads are at getting people through their doors. Current listing platforms give uniformed and many times inaccurate reviews of local businesses due to a biased and outdated rating system. Local businesses need a better way to advertise themselves and directly market their venue, products & events to potential customer in a targeted and real-time manner.

The current subject matter includes a social media platform that uses real-time data to rate and promote local businesses and address the problems of current advertising and media convention. When businesses create an account on the subject platform, their place of business becomes a visible entity with an associated geolocation on an application page. From the associated geolocation user of the subject platform can document, post and share media content as long as their location (via GPS or other geo-location method) is in proximity to the associated geolocation of the entity. The posted media is then organized in to a short term feed visible to all users of the platform. Local businesses are given a rating based on a parameter related the amount of media posted from their associated geolocation per hours (or other unit), the more content posted by users to the associated geolocation, the higher rating the entity receives, this parameter may be a running average of the last hour or similar metric.

The subject platform provides local businesses the power to effectively market themselves without relying on listing sites that allow biased and outdated crowdsourced reviews.

### BRIEF DESCRIPTION OF THE DRAWINGS

FIG. 1 is a flow chart of the geo-location based posting of content according to an embodiment of the disclosed subject matter.

FIGS. 2-4 are an illustration of a real time media based rating system for geo-fenced areas according to an embodiment of the disclosed subject matter.

FIG. 5 is a flow chart of the automated Media feed posting according to an embodiment of the disclosed subject matter.

FIGS. 6-7 are an illustration of geo-fenced area based push notifications according to an embodiment of the disclosed subject matter.

FIG. 8 is an illustration of an attribution feedback loop according to an embodiment of the disclosed subject matter.

FIG. 9 is an illustrative flow chart for temporary events according to an embodiment of the disclosed subject matter.

### DETAILED DESCRIPTION

The subject digital platform includes media posting restrictions that only allow media to be posted from a geo-fenced geo-location in real-time. Geo-fencing being a defined border around a geographic location associated with an entity (local business). It is envisioned that the border may be designated as a function of distance from a point, a grouping of blocks, streets, roads, rivers, political lines or other geographic features, in addition the border may be designated by wireless access points such as cell towers and/or wi-fi networks. The boundary is associated with the entity by the platform operator, and the size and location being subject to change based on factors such as adjacent entities and subscriber level.

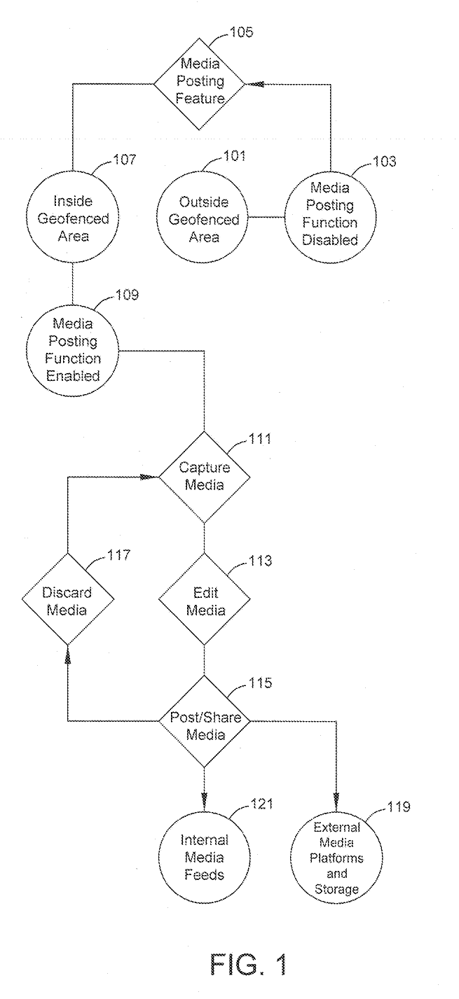

FIG. 1 illustrates the process in with media is posted by a user. If a user is outside of the geo-fenced area associated with an entity, as shown in circle (101), the media creation and posting on the client's device is disabled as shown in circle (103). Thus when the client's geo-location falls outside of a geo-fenced area (101), when within the application, the user is unable to generate content for the entity, alternatively, the user will be able to generate content, but not allowed to post to the platform. Media creation and posting on the client's device is enabled when the client's geo-location falls inside of a geo-fenced area as shown in circles (107) and (109).

Diamonds 111-117 illustrate the process in which content is captured within the application by the user. As noted previously, the capture of content may be allowed outside the geo-fenced area (101) but would be prohibited from being posted to the platform. Media created inside the digital platform is sharable to external media platforms and storage as shown in circle (119), external meaning outside the subject platform. The internal media feeds (121) are associated with the subject platform and are distributed in accordance with the provisions of the platform. (e.g. to others wireless devices within the geo-fenced area, the entity etc.) Media created from outside of the digital platform is restricted. Alternatively, content that is captured and geo and time tag within the geo-fenced area, may later be posted, based on the tags even if the user is outside the geo-fenced area.

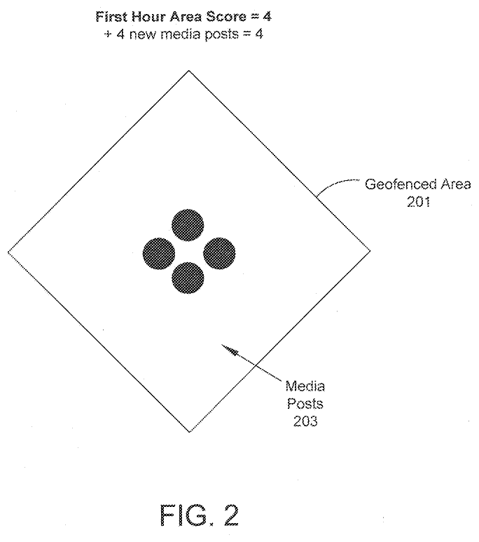

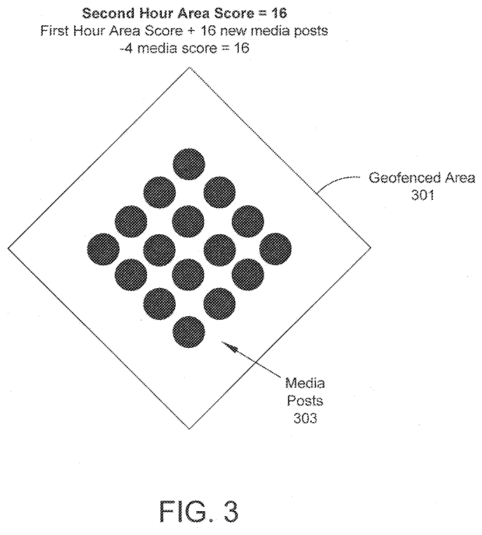

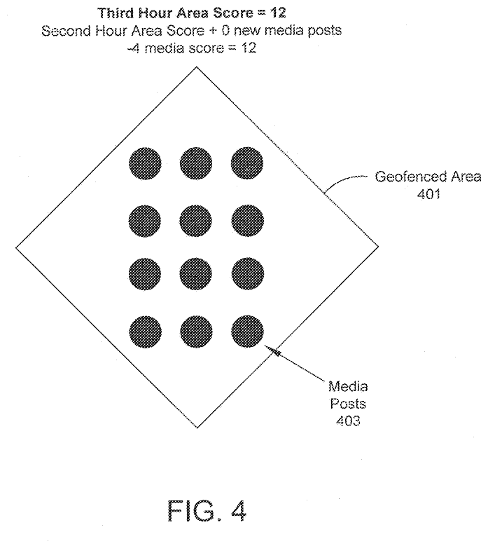

As shown in FIGS. 2-4, posted media quantities (203) from geo-fenced areas (201) are documented over a determined period of time and given a number, symbol, word, verbal or color status based on the quantities documented. The larger the posted media quantities documented the higher the geo-fenced area's number, symbol, word, verbal or color status will be. Over the same determined period of time the media quantity score will dilute consistently by a determined factor. A geo-fenced area's number, symbol, word, verbal or color status rises in score, falls in score or the score stays the same over the determined period of time based on the amount of posted media or lack thereof.

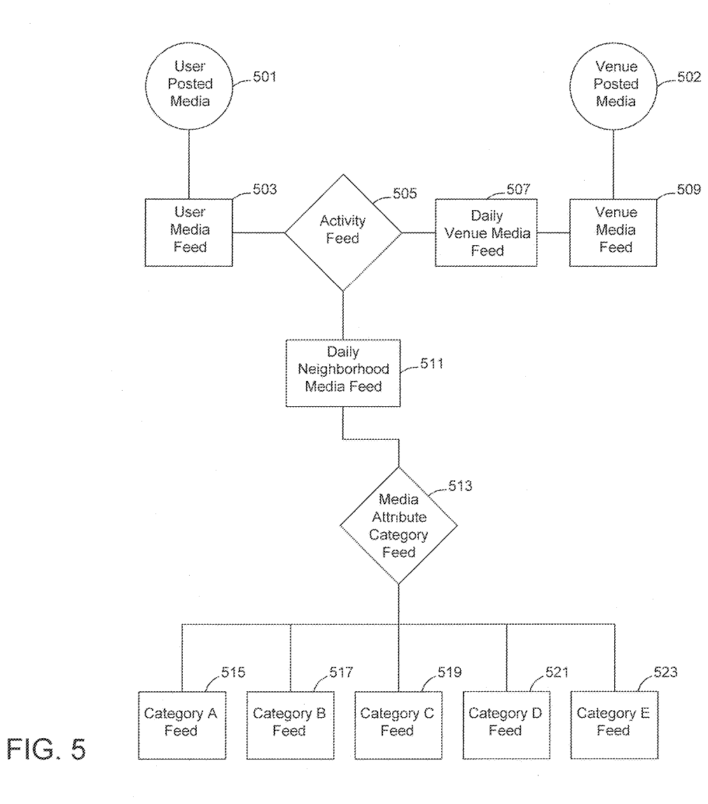

Posted media is automatically distributed to multiple feeds on the platform as shown in FIG. 5. The Daily Feed displays media posted from a geo-fenced geo-location within a 24 hour period (507), the User Feed displays media posted by a client account from geo-fenced geo-locations (505), the Venue Feed displays media posted from a geo-fenced geo-location (509), the Daily Neighborhood Feed displays media posted from geo-fenced within a defined neighborhood within a 24 hour period (511) and the Activity Feed displays media posted from any and all geo-fenced geo-location relevant to matching category attributes (513). The category attributes (characteristics) may include most viewed, most hyped (promoted), active, treading, promoted.

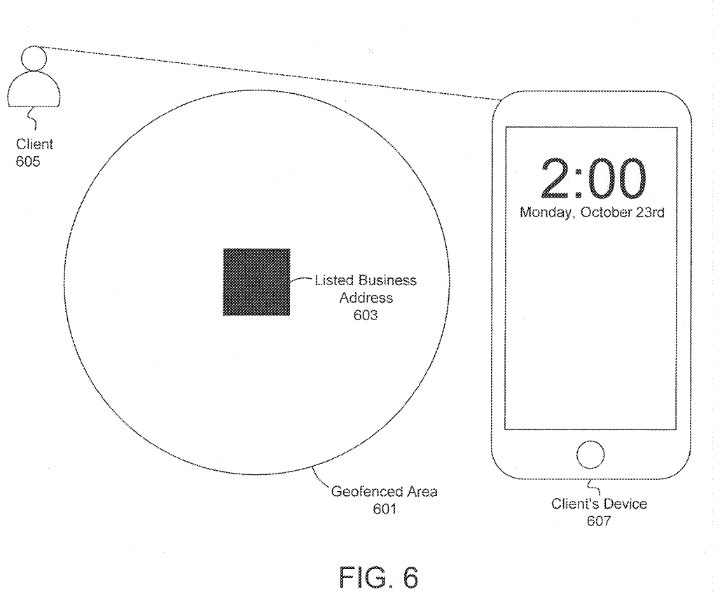

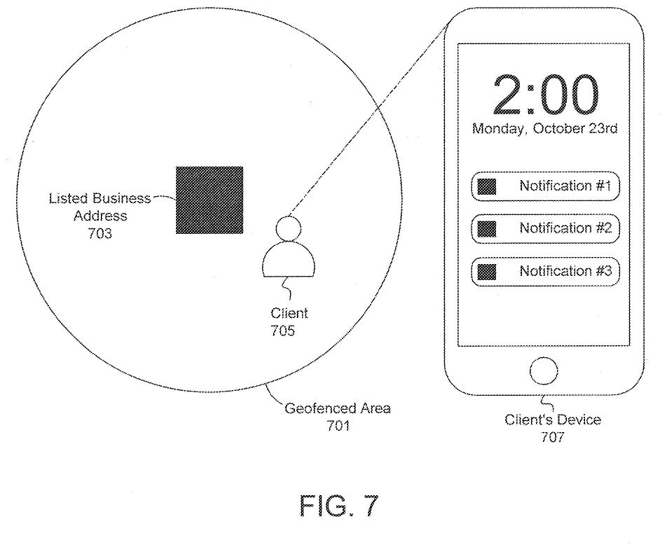

Notifications (FIGS. 6 and 7) are pushed to client devices (607) relative to the client device's geo-location (605, 705) and its proximity to geo-fenced areas (601, 701) on the platform. Push notification scripts are customizable by client accounts with special privileges.

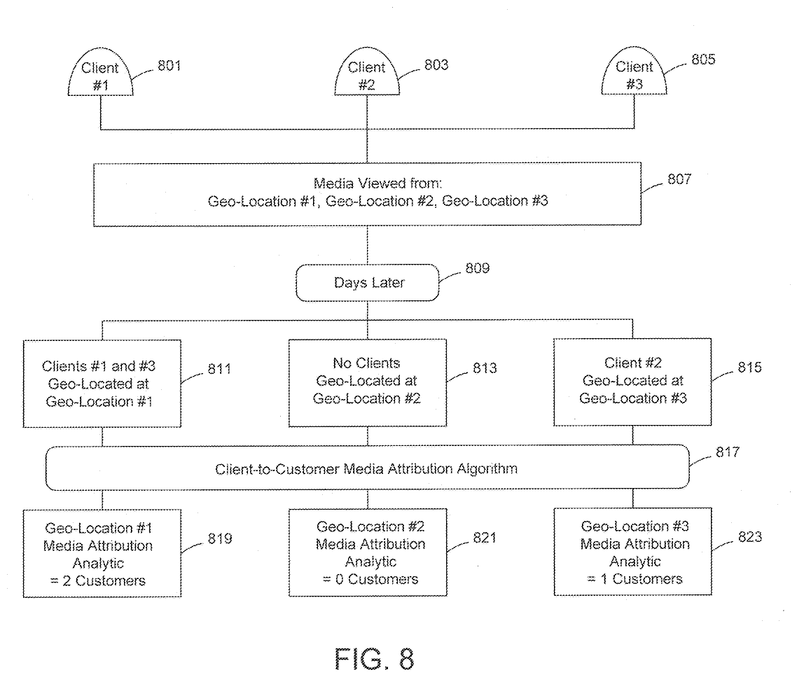

As shown in FIG. 8, client geo-location data (801) is recorded in conjunction with viewed media data (807) to produce the client-to-customer media attribution analytic (817, 819, 821, 823). The client-to-customer media attribution (817, 819, 821, 823) analytic records the amount of client devices who view media posted from a geo-fenced geo-location and over time are registered at the geo-fenced geo-location that the viewed media was originally posted from (811, 813, 815).

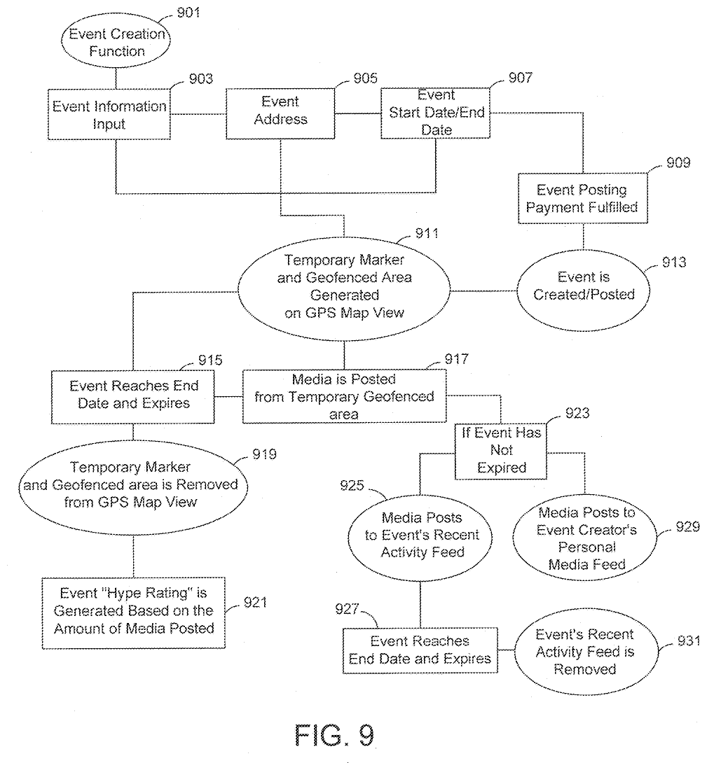

End users (both Business and User Accounts) may have the ability to create Events as shown in FIG. 9. When new events are being created (901), the end user will input all information regarding the event (e.g. event name, address, start/end date, hosting hours, event description/category, etc.) as shown in (901, 903, 905, 907). Once all posting fees (909) have been satisfied a temporary marker/reference area is generated on the app's GPS map at the temporary event's registered address as shown in (911). The temporary marker and accompanying geo-fenced area may remain active until the registered “end date/time” of the created event as shown in (915). It may also remain posted as an inactive or historical listing.

After the temporary marker/geo-fenced area is generated (911), end users in the location bounded by the temporary event's geo-fenced area may be able to create and post media content to the event's media feed as shown in (917). At the event's expiration (915), the temporary maker and geo-fenced area may be removed from the app's GPS or other geo-location systems map, including all media posted to the event's recent media feed as shown in (919).

The posted media from the expired event may be accessible by the event creator and appear on their personal media feed as shown in (929). Also upon expiration, the event may receive its own “Hype Rating” that will be determined based on the total amount of media posted throughout the duration of the event or another suitable metric (e.g. rate of postings, comparisons with other events, saturation of area, individual and group postings, etc.) as shown in (921).

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise. For example, the term “a compound” or “at least one compound” may include a plurality of compounds, including mixtures thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the description/aspects/claims.

What I claim is:

1. In a media platform comprising a server and a plurality of hand held wireless devices, a method of providing information comprising:
defining a geographic boundary associated with an entity;
determining that ones of the plurality of hand held wireless devices are within the geographic boundary;
allowing the users of the ones of the plurality of hand held wireless devices to create and post content to the server via the respective hand held wireless devices;
associating the posted content with the entity; and,
transmitting the content to others of the plurality of hand held wireless devices.

2. The method according to claim 1, wherein the others of the plurality of hand held wireless devices are within the geographic boundary associated with the entity;

3. The method according to claim 1, further comprising the step wherein the others of the plurality of hand held wireless devices request information from the central server.

4. The method according to claim 3, where in the requested information is associated with a political area in which the geographic boundary is contained.

5. The method according to claim 3, wherein the requested information is associated with the entity.

6. The method according to claim 1, further comprising determining a rating parameter associated with the entity as a function of the posted content and the respective ones of the plurality of hand held wireless devices.

7. The method according to claim 6, wherein the rating parameter is time weighted.

8. The method according to claim 1, wherein the step of transmitting the content further comprises a map overlay indicating the location of the entity.

9. The method according to claim 1, wherein the step of creating and posting content comprises taking electronic photographs.

10. The method according to claim 1, wherein the step of creating and posting content comprises rating the entity.

11. The method according to claim 5, wherein the content is provided as a feed of content associated with the entity recently received.

12. The method according to claim 1, further comprising the step of aggregating content for distribution by the entity.
